(19) United States
(12) Patent Application Publication
(10) Pub. No.: US 2025/0018616 A1
(43) Pub. Date: Jan. 16, 2025

(54) CASTING SHELL FOR A CASTING DEVICE AND METHOD FOR MANUFACTURING A FILTER ELEMENT

(71) Applicant: MANN+HUMMEL GmbH, Ludwigsburg (DE)

(72) Inventors: Pascal NEEF, Trossingen (DE); Thomas SIEBER, Marklkofen (DE); Thomas VILSMAIER, Marklkofen (DE); Joachim-Paul KRIEGER, Reisbach (DE); Friedrich KUPFER, Marklkofen (DE)

(21) Appl. No.: 18/897,017

(22) Filed: Sep. 26, 2024

Related U.S. Application Data
(63) Continuation of application No. PCT/EP2023/053443, filed on Feb. 13, 2023.

(30) Foreign Application Priority Data
Mar. 28, 2022 (DE) 102022107265.7

(51) Int. Cl. B29C 39/26; B01D 46/00; B29C 39/02; B29L 31/14

(52) U.S. Cl. CPC B29C 39/26; B01D 46/0001; B29C 39/026; B29L 2031/14

(57) ABSTRACT

A casting shell for producing a filter element with a filter body and a seal or end disk has a receiving shell with a groove and a support surface. The groove receives casting material. The support surface supports the filter body during casting. A cover is provided with at least two cover parts arranged so as to be movable separately from each other relative to the receiving shell. The cover parts open the groove in a first position and in a second position, with the filter body inserted as intended in the casting shell, cover the groove. A bottom side of the cover parts faces in the second position a cavity formed by the groove. The bottom side molds a seal or function surface of the seal or end disk. A casting device is provided with such a casting shell. A method using such a casting shell is provided.

### CROSS-REFERENCE TO RELATED APPLICATIONS

This application is a continuation application of international application No. PCT/EP2023/053443 having an international filing date of 13 Feb. 2023 and designating the United States, the international application claiming a priority date of 28 Mar. 2022 based on prior filed German patent application No. 10 2022 107 265.7, the entire contents of the aforesaid international application and the aforesaid German patent application being incorporated herein by reference.

### BACKGROUND

The invention concerns a casting shell for producing a filter element for filtering a fluid with a filter body, a casting device with a casting shell, and a method for producing a filter element for filtering a fluid with a filter body by a casting shell.

Usually, casting shells for attaching an end disk and/or seal to a filter element are comprised of two separate halves or parts, a bottom shell and a top shell, which are positioned on top of each other. Both shells are sprayed or wetted with a release agent, respectively, so that the cast or foamed-on end disk and/or seal, for example, of polyurethane (PUR), can be easily removed therefrom after casting and no residues of PUR stay behind.

JP 2017177369 A discloses a device for producing a filter element, comprising: a molding tool with a plurality of divided molds which form a cavity in that they are clamped such that a resin material is foamed in the cavity in order to integrally form a seal part on an outer circumferential edge of a filter material. The molding tool is arranged during foaming of the resin material between the cavity and a gap between the plurality of divided mold pair surfaces and enables the passage of air out of the cavity to the gap. Further, the device comprises a regulating element for regulating the passage of a resin material during foaming.

Further, DE 691 00 895 T2 discloses a device for producing an air filter which comprises a bottom casting shell as well as a top casting shell which are connected pivotably to each other. The top casting shell comprises a frame which, in a closed state of the device, encloses a filter body placed on the bottom casting shell. The frame comprises four sidewalls surrounding the filter body on all sides, wherein the entire frame is moveable by a drive device in relation to a base body of the top casting shell.

### SUMMARY

It is an object of the invention to provide an improved casting shell for producing a filter element for filtering a fluid with a filter body with a molded-on seal and/or end disk.

A further object is to provide a casting device with such an improved casting shell.

A further object is to provide a method for producing, by such an improved casting shell, a filter element for filtering a fluid with a filter body and a molded-on seal and/or end disk.

The aforementioned object is solved according to an aspect of the invention by a casting shell for producing a filter element for filtering a fluid with a filter body and a seal and/or an end disk at least partially circumferentially extending around the filter body, the casting shell comprising a receiving shell for receiving a casting material in a groove with a support surface for the filter body and comprising a cover with at least two cover parts arranged so as to be movable separately from to each other in relation to the receiving shell, which open the groove in a first position and in a second position, with the filter body inserted as intended, substantially cover the groove, wherein a bottom side of the at least two cover parts, which in the second position faces a cavity formed by the groove, is embodied for molding a seal surface or function surface of the seal and/or end disk.

The further object is solved by a casting device comprising a casting shell according to the invention, wherein a filter body can be inserted as intended in the casting shell, and comprising a metering device with which the casting material can be filled into the groove of the receiving shell of the casting shell.

The further object is solved by a method for producing, by a casting shell according to the invention, a filter element for filtering a fluid with a filter body and a seal and/or end disk at least partially circumferentially extending around the filter body, wherein a filter body in a first position of the cover parts is placed with an end face as intended on the receiving shell so that the filter body with an outer rim at least partially projects into a groove of the casting shell, wherein casting material is filled into the groove, and wherein the at least two cover parts are moved separate from each other into the second position, and the receiving shell and the at least two cover parts in the second position enclose a cavity formed by the groove so that a bottom side of the at least two cover parts, which faces the cavity in the second position, is embodied for molding a seal surface or function surface of the seal and/or end disk.

Beneficial embodiments and advantages of the invention result from the additional claims, the description, and the drawing.

According to an aspect of the invention, a casting shell is proposed for producing a filter element for filtering a fluid with a filter body and a seal and/or end disk surrounding at least partially the filter body. The casting shell comprises a receiving shell for receiving a casting material in a groove with a support surface for the filter body and comprises a cover with at least two cover parts arranged so as to be movable separately from each other in relation to the receiving shell, which in a first position open the groove and in a second position substantially cover the groove with the filter body inserted as intended.

A bottom side of the at least two cover parts which faces a cavity formed by the groove in the second position is embodied for molding a seal surface or function surface of the seal or end disk so that an upper seal surface or function surface at the end disk and/or seal can be realized beneficially within the casting shell.

By means of the casting shell, an end disk and/or a seal can be molded on the filter body, in particular foamed on. The filter body may be embodied as a folded bellows of a filter medium folded in a zigzag shape.

Herein, “movable separately from each other” may mean that the cover parts, independently from each other, are able to carry out a movement with different degrees of freedom of movement, for example, a respective different translatory and/or rotatory movement. In this context, it is however not precluded that a kinematic coupling exists, for example, by a common drive, between the movements of the individual cover parts.

It is important for the invention that the at least two cover parts are arranged so as to be movable separately from each other in relation to the receiving shell because in this way the casting process for very tall filter bodies, in particular for folded filter bodies with great fold heights, is significantly facilitated. With casting devices known from the prior art which comprise a top shell pivotably joined to a bottom shell, this is no longer possible beginning at a certain height limit of the filter body because the top shell would collide with the filter body when pivoted. The casting shell of the present invention, on the other hand, makes it possible to mold seals and/or end disks to filter bodies with height dimensions of an arbitrary size and yet it is characterized by a very compact configuration.

Proposed is a single casting shell which comprises one or a plurality of pivotable or differently moveable components. These pivotable or differently movable components form in the folded state essentially a “top shell”. Beneficially, the components are pivotable by up to 180° so that an optimal application of the release agent is possible. Locking of the pivotable or differently movable parts during the casting process can be realized, for example, by a mechanical catch mechanism or by means of a magnetic device in order to ensure the foam counter pressure during the casting process. In this manner, an upper seal surface or function surface at the PUR end disk and/or seal can be realized beneficially within the casting shell.

In embodiments, an arrangement with slidable components can be provided also. In such an embodiment, the application of the release agent is however somewhat more complex.

The receiving shell and the at least two cover parts enclose a cavity which is formed by the groove when the filter body is placed as intended on the receiving shell and which serves for attaching an at least partially circumferentially extending seal to an outer rim of an end face of the filter body. The seal can be produced, for example, by casting, foaming or foam-molding a plastic material, in particular PUR. The seal may be configured to extend completely circumferentially.

An advantage of the proposed casting shell is that no separate casting top shell is required, whereby handling and/or logistics in a production line is simplified. Further, only a single process for applying the release agent in the casting shell is required, whereby the production is accelerated. Advantageously, furthermore function surfaces and/or seal surfaces at existing devices can be realized which are not designed for casting shells with a separate top shell. In this way, the production process can be simplified and designed less expensively.

According to a beneficial embodiment of the casting shell, the at least two cover parts can be supported at the receiving shell so as to be movable separately from each other, respectively. In particular, in this context each of the cover parts comprises its own degree of freedom of movement, different from the other cover parts, in relation to the receiving shell.

According to a beneficial embodiment of the casting shell, the groove can comprise at its inner side a groove wall which is lower than a groove wall at its outer side. At the inner groove wall, the support surface for the filter body is formed. In particular, the support surface for the filter body can be embodied horizontally in this context. In this manner, the filter body can be placed safely on the receiving shell for the casting process.

Advantageously, the groove can be designed to extend circumferentially around the receiving shell. The filter body placed on the support surface seals the groove in relation to the interior so that the casting material remains in the cavity which is formed by the groove and the filter body. The casting shell can be designed annularly or rectangularly, for example. For example, the casting shell can be embodied in a cup shape with a bottom.

According to a beneficial embodiment of the casting shell, the at least two cover parts each can be arranged at the receiving shell so as to be pivotable about their own axis which is arranged parallel to the support surface for the filter body. In particular, the at least two cover parts can be pivotable by 180°, respectively. In the open state, the cover parts advantageously can be sprayed or wetted with release agent in order to be able to safely remove the filter element with foamed-on seal. In embodiments, the pivot axes of the two cover parts can extend parallel but are spaced apart from each other in this case. However, the pivot axes of the two cover parts never coincide.

According to a beneficial embodiment of the casting shell, the at least two cover parts can be arranged at the receiving shell so as to be slidable parallel to the support surface for the filter body in different directions, respectively. Alternatively, also an arrangement with slidable components can be provided. Such an embodiment is in particular advantageous when the shape of the filter element does not provide the structural space for folding cover parts. The directions in which the two cover parts are slidable parallel to the support surface can be oriented parallel to each other in embodiments or can be directed in different directions.

Advantageously, a combination of pivotable and slidable cover parts is possible also.

According to a beneficial embodiment of the casting shell, a fastening device can be present with which the at least two cover parts can be fixed in the second position. In particular, the fastening device can be a mechanical fastening device and/or a magnetic fastening device. Locking of the folding parts during the casting process can be realized, for example, by a mechanical catch mechanism or by means of a magnetic device in order to ensure the foam counter pressure during the casting process. In this manner, an upper seal surface or function surface at the PUR end disk and/or seal can be realized beneficially within the casting shell.

According to a beneficial embodiment of the casting shell, the at least two cover parts in the second position can provide a free space in the casting shell which is larger than a cross section of the filter body inserted as intended in the casting shell. In this way, the filter body inserted as intended can be spaced apart by a gap in relation to the closed cover parts. In this way, the casting material can be advantageously foamed onto the filter body and form a certain protrusion between the actual seal surface and the filter body.

According to a beneficial embodiment of the casting shell, side faces of the at least two cover parts which adjoin in the second position an outer side of the filter body can be configured with a complementary shape to the outer side of the filter body. In this manner, the at least two cover parts, when the filter body is inserted, can advantageously seal the cavity formed by the groove against the filter body during the casting process.

According to a beneficial embodiment of the casting shell, end faces bordering one another of the at least two movable cover parts can adjoin each other seal-tightly in the second position. In this way, with the filter body inserted, the cavity formed by the groove can be reliably circumferentially sealed against the filter body during the casting process.

According to a further aspect of the invention, a casting device with a casting shell is proposed, wherein the casting shell comprises a receiving shell for receiving a casting material in a groove with a support surface for the filter body and comprises a cover with at least two cover parts arranged so as to be movable separately from each other in relation to the receiving shell, which open the groove in a first position and in a second position, with the filter body inserted as intended, cover substantially the groove, and wherein a bottom side of the at least two cover parts, which faces the cavity in the second position, is configured for molding a seal surface or function surface of the seal. The casting device comprises furthermore a metering device with which casting material can be filled into the groove of the receiving shell of the casting shell.

With the proposed casting device with a casting shell, an upper seal surface or function surface can be realized at the PUR end disk and/or seal in a beneficial manner within the casting shell. The at least two movably arranged cover parts are configured so as to be pivotable or slidable separately from each other.

The receiving shell and the at least two cover parts enclose, with the filter body placed on the receiving shell as intended, a cavity formed by the groove which serves for applying an at least partially circumferentially extending seal at an outer rim of an end face of the filter body. The seal can be produced, for example, by casting, foaming or foam-molding of a plastic material, in particular of PUR.

An advantage of the proposed casting device is that no separate casting top shell is required, whereby handling and/or the logistics in a production line is simplified. Further, only a single process for applying the release agent in the casting shell is required, whereby the production is accelerated. Advantageously, furthermore function surfaces and/or seal surfaces at existing devices can be realized which are not designed for casting shells with a separate top shell. In this way, the production process can be simplified and designed less expensively.

According to a beneficial embodiment of the casting device, the at least two cover parts can be designed to seal-tightly adjoin the filter body inserted as intended in the casting shell. In particular, the at least two cover parts can be designed to adjoin seal-tightly at least in sections. In this manner, the at least two cover parts, with inserted filter body, can seal the cavity formed by the groove advantageously against the filter body during the casting process.

According to a beneficial embodiment of the casting device, the at least two cover parts can be designed so as to be spaced apart by a gap from the filter body inserted as intended in the casting shell. In particular, the at least two cover parts can be designed so as to be spaced apart at least in sections by a gap from the filter body. In this manner, the casting material can be advantageously foamed onto the filter body and form a certain protrusion between the actual seal surface and the filter body.

According to a beneficial embodiment, the casting device can comprise a hold-down for fixation of the filter body during the casting process in the casting shell. In this way, it can be prevented that the filter body floats up during the casting process due to the foamed casting material and that tolerances that are too large result thus in the casting process.

According to a further aspect of the invention, a method is proposed for producing a filter element for filtering a fluid with a filter body by a casting shell, wherein the casting shell comprises a receiving shell for receiving a casting material in a groove with a support surface for the filter body and comprises a cover with at least two cover parts movable separately from each other in relation to the receiving shell, which open the groove in a first position and in a second position, with filter body inserted as intended, substantially cover the groove, and wherein a bottom side of the at least two cover parts, which faces the cavity in the second position, is configured for molding a seal surface or function surface of the seal. In this context, the filter body is placed with an end face as intended on the receiving shell in a first position of the cover parts so that the filter body projects with an outer rim at least partially into a groove of the casting shell. The at least two cover parts are moved, separate from each other, into the second position and the receiving shell and the at least two cover parts enclose a cavity formed by the groove in the second position.

Advantageously, the cavity, with the filter body placed on the receiving shell as intended, serves for applying an at least partially circumferentially extending seal to the outer rim of the end face of the filter body.

The receiving shell and the at least two cover parts, with the filter body placed as intended on the receiving shell, enclose a cavity formed by the groove which serves for applying an at least partially circumferentially extending seal to an outer rim of an end face of the filter body. The seal can be produced, for example, by casting, foaming or foam-molding of a plastic material, in particular of PUR.

An advantage of a proposed method with the casting shell is that no separate casting top shell is required whereby handling and/or the logistics in a production line is simplified. Further, only a single process for applying the release agent in the casting shell is required, whereby the production is accelerated. Advantageously, furthermore function surfaces and/or seal surfaces at existing devices can be realized which are not designed for casting shells with separate top shell. In this way, the production process can be simplified and designed less expensively. In addition, due to the removal of the covers in lateral direction it is possible to apply seals to slanted end faces or slanted filter bellows.

According to a beneficial embodiment, a method may comprise: filling of the groove with an in particular foamable casting material, in particular polyurethane; moving the at least two cover parts from the first position into the second position; inserting the filter body; forming the seal at the outer rim of the end face of the filter body; moving back the at least two cover parts into the first position; removing the filter body from the support surface of the receiving shell. Forming the seal takes place in this context automatically by foaming of the casting material in the groove. In this manner, the seal of the filter element can be produced very efficiently and cost effectively because in particular handling of the casting shell with movable cover parts is significantly easier and, additionally, seal surfaces or function surfaces can be realized very reliably.

According to a beneficial embodiment of a method, prior to placing the filter body on the receiving shell, inner surfaces of the groove and bottom sides of the at least two cover parts can be provided with a release agent. In this manner, the seal of the filter element can be produced very efficiently because in particular the application of the release agent prior to the actual casting process is facilitated by the movable cover parts.

According to a beneficial embodiment of a method, after placing the filter body on the receiving shell, the filter body can be fixed by a hold-down which is removed again prior to removal of the filter body from the receiving shell. In this way, it can be prevented that the filter body during the casting process floats up by the foamed casting material and that tolerances that are too large will thus result in the casting process.

### BRIEF DESCRIPTION OF DRAWINGS

In the drawings, embodiments of the invention are illustrated. The drawings, the description, and the claims contain numerous features in combination. A person of skill in the art will expediently consider the features also individually and combine them to expedient further combinations.

FIG. 1 shows a plan view of a casting device with a casting shell according to an embodiment of the invention.

FIG. 2 shows a plan view of a casting device with a casting shell according to a further embodiment of the invention.

FIG. 3 shows a longitudinal section through the casting device according to FIG. 2 with placed-on filter element and partially foamed-on seal.

FIG. 4 shows a longitudinal section through the casting device according to FIG. 2 with a placed-on filter element of a different configuration and foamed-on seal.

FIG. 5 shows a plan view of a casting device with a casting shell according to a further embodiment of the invention.

FIG. 6 shows a longitudinal section through the casting device according to FIG. 5 with placed-on filter element.

FIG. 7 shows a longitudinal section through the casting device according to FIG. 5 with placed-on filter element and foamed-on seal.

### DETAILED DESCRIPTION

In the Figures, same or same-type components are identified with same reference characters. The Figures show only examples and are not to be understood as limiting.

Directional terminology used in the following with terms like “left”, “right”, “top”, “bottom”, “in front of”, “behind”, “thereafter” and the like serves only for better understanding of the Figures and in no way is to represent a limitation of the generality. The illustrated components and elements, their design and use can vary in the context of considerations of a person of skill in the art and be adapted to the respective applications.

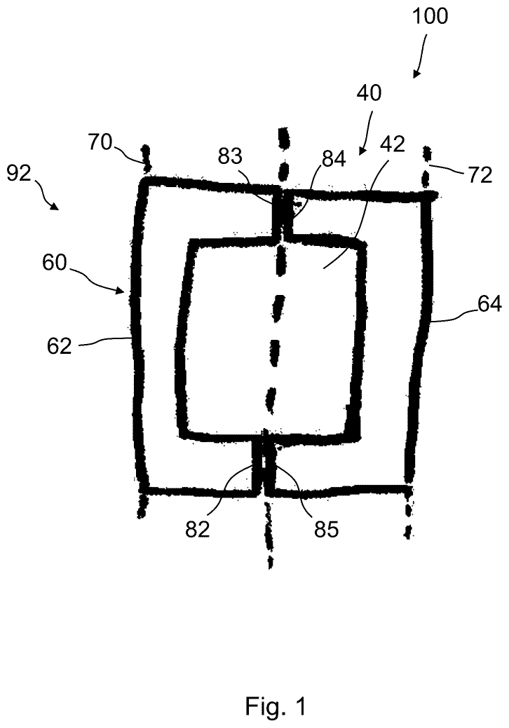

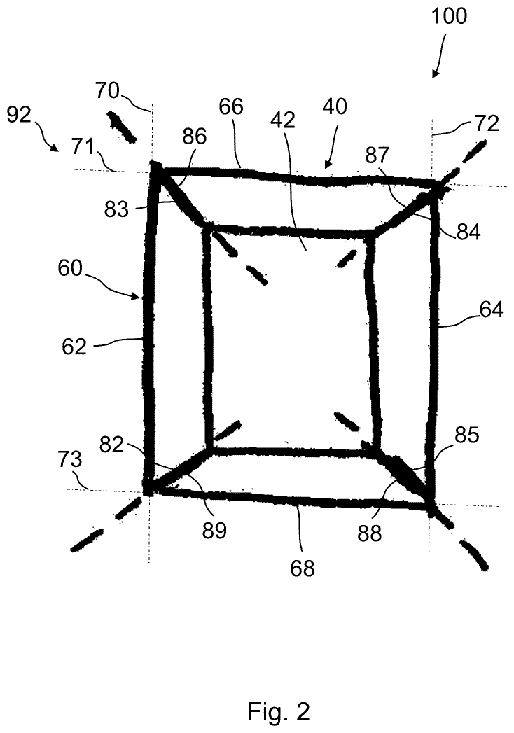

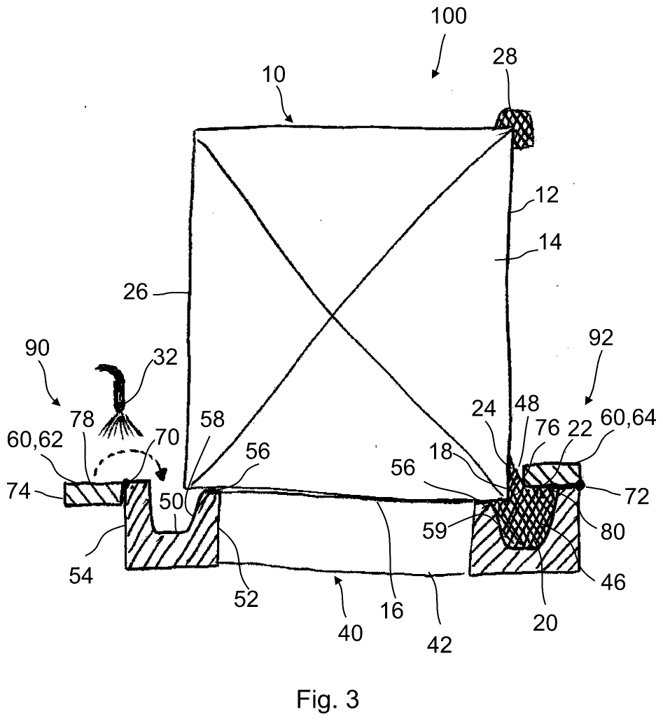

FIG. 1 shows a plan view of a casting device 100 with a casting shell 40 according to an embodiment of the invention. FIG. 2 shows a plan view of a casting device 100 with a casting shell 40 according to a further embodiment of the invention while in FIG. 3 a longitudinal section through the casting device 100 according to FIG. 2 with placed-on filter element 10 and partially foamed-on seal 20 is illustrated.

The casting device 100 serves for producing a filter element 10 for filtering a fluid with a filter body 12 and comprises for this purpose a casting shell 40. The casting shell 40 comprises a receiving shell 42 for receiving a casting material in a groove 50 with a support surface 56 for the filter body 12. Further, the casting shell 40 comprises a cover 60 with at least two cover parts 62, 64 which are arranged to be movable separately and which open the groove 50 in a first position 90 and in a second position 92 cover substantially the groove 50, with the filter body 12 inserted as intended.

The casting shell 40 in principle can be configured annularly or rectangularly. In the embodiments illustrated in FIGS. 1 through 7, the casting shell 40 is designed rectangularly, respectively.

The embodiment in FIG. 1 comprises two cover parts 62, 64 which are arranged to be movable separately and are embodied in a U shape. The cover parts 62, 64 can be pivoted about the axes 70, 72, preferably by 180°, so that they can be opened fully. The axes 70, 72 are parallel to each other but spaced apart from each other. In FIG. 1, the second position 92 is illustrated in which the cover parts 62, 64 in the folded state are lying on the receiving shell 42. In the second position 92, the two cover parts 62, 64 abut each other with end faces 82 and 85, respectively, 83 and 84 and close seal-tightly so that a seal-tight cover 60 results on the receiving shell 42.

The embodiment in FIG. 2 comprises four movably arranged cover parts 62, 64, 66, 68 which are embodied in a trapezoidal shape. The cover parts 62, 64, 66, 68 can be pivoted about the axes 70, 71, 72, 73, preferably by 180°, so that they can be fully opened. In this context, a pair of axes, namely the axis 70 and the axis 72 as well as the axis 71 and the axis 73, are pivotable parallel to each other, wherein the parallel axes are however spaced apart from each other. Each one of the cover parts 62, 64, 66, 68 is pivotable about its own axis 70, 71, 72, 73. In FIG. 2, the second position 92 is illustrated in which the cover parts 62, 64, 66, 68 are lying on the receiving shell 42 in the folded state. The cover parts 62, 64, 66, 68 abut each other in the second position 92 with end faces 82 and 89, 83 and 86, 84 and 87, 85 and 88 and seal-tightly close so that a seal-tight cover 60 results on the receiving shell 42.

In FIG. 3, the casting device 100 is illustrated with the filter body 12 placed on the support surface 56 of the receiving shell 42 and, for example, formed of a folded filter medium 14. In longitudinal section, details of the mechanism of the movable cover elements 62, 64 in interaction with the groove 50 of the receiving shell 42 are illustrated.

At the left side of FIG. 3, the cover part 62 is illustrated in the first position 90, i.e., in the open state, while at the right side of FIG. 3 the cover part 64 is illustrated in the second position 92, i.e., in the folded state. In this context, the groove 50 is already filled with the foamed-on seal 20.

The groove 50 comprises at its inner side a groove wall 52 which is lower than the groove wall 54 at its outer side. At the inner groove wall 52, the support surface 56 for the filter body 12 is formed. The support surface 56 for the filter body 12 may be horizontally embodied in this context.

The groove 50 can be embodied to extend circumferentially around the receiving shell 42. In this context, the filter element 10, placed on the support surface 56, seals the groove 50 inwardly because the filter element 10 with its outer rim 18 projects into the groove 50.

The casting shell 42 can be configured advantageously like a cup with bottom.

The two cover parts 62, 64 each are arranged at the receiving shell 42 so as to be pivotable, in particular pivotable about 180°, separately from each other about their own axis 70, 72 arranged parallel to the support surface 56 for the filter body 12. The axes 70, 72 are spaced apart from each other.

Advantageously, a fastening device (not illustrated) can be present with which the at least two cover parts 62, 64 can be fixed in the second position 92. Such a fastening device can be embodied, for example, as a mechanical fastening device, in particular as a catch mechanism, or as a magnetic fastening device. In this way, the cover parts 62, 64 can be fixed in the folded state.

Side faces 74, 76 of the two cover parts 62, 64 bordering an outer side 26 of the filter body 12 in the second position 92, are configured with a complementary shape to the outer side 26 of the filter body 12. In this way, the two cover parts 62, 64 can seal-tightly adjoin the filter body 12. In particular, they can at least in sections seal-tightly adjoin the filter body 12. In this way, the casting material remains in the cavity 46 which is formed by the groove 50 and the filter body 12.

In an alternative embodiment, the two cover parts 62, 64 in the second position 92 can provide a free space in the casting shell 40 which is larger than a cross section of the filter body 12 inserted as intended in the casting shell 40. In this way, the filter body 12, inserted as intended, is spaced apart by a gap 48, in particular spaced apart in sections, in relation to the cover parts 62, 64.

In the second position 92, when the cover parts 62, 64 in the folded state are lying on the receiving shell 42 and the filter body 12 is inserted, the groove 50 forms with the respective cover parts 62, 64 an enclosed cavity 46, in which the casting material can be filled and foamed.

Bottom sides 78, 80 of the two cover parts 62, 64, which faces the cavity 46 in the second position 92, are embodied in this context for molding a seal surface 22 when applying a seal 20. In this manner, an upper seal surface or function surface can be realized beneficially at the PUR end disk and/or seal 20 within the casting shell.

According to the proposed method, the filter body 12 in a first position 90 of the cover parts 62, 64 is placed with an end face 16 as intended on the receiving shell 42 so that the filter body 12 with the outer rim 18 projects at least partially into the groove 50 of the casting shell 40. The two cover parts 62, 64 are then moved into the second position 92. In this way, the receiving shell 42 and the two cover parts 62, 64 enclose the cavity 46 formed by the groove 50 in the second position 92.

Thereafter, the groove may be filled with a casting material, for example, polyurethane. The casting material foams and forms in this way the circumferentially extending seal 20 at the outer rim 18 of the end face 16 of the filter body 12. Filling in the casting material can be realized in particular by means of a metering device so that always the correct quantity of casting material is precisely filled into the groove.

After completion of the casting process, the two cover parts 62, 64 are moved into the first position 90 and the filter body 12 is removed from the support surface 56 of the receiving shell 42.

Advantageously, prior to placing the filter body 12 on the receiving shell 42, the inner surfaces 58, 59 of the groove 50 and the bottom sides 78, 80 of the at least two cover parts 62, 64 are provided with a release agent in order to be able to subsequently more easily remove the filter element 10 with the completed seal 20. The spraying of or wetting with the release agent is carried out with the cover parts 62, 64 open in the first position 90. In FIG. 3, a release agent spraying device 32 is schematically illustrated in this respect.

Due to the gap 48 which is formed between the cover parts 62, 64 and the outer side 26 of the filter body 12, the casting material upon foaming can rise at the outer side 26 and form a protrusion 24.

At a top corner of the filter body 12, a protective rim 28 can be seen which can be attached in a conventional manner. For example, the protective rim 28 can be comprised of a plastic material and be injection-molded, glued or foamed on. The protective rim 28 can be designed in a strip shape or can also comprise a plurality of knobs. Since the cover 60 of the casting shell 40 can be moved away to the side and must not be removed in upward direction as in conventional casting shells, there are no limitations in respect to the shape and dimensions, in particular the extension in radial direction, of the protective rim 28. Thus, it is possible, for example, that the protective rim 28 when projected on the seal 20 extends to the seal surface 28 or beyond.

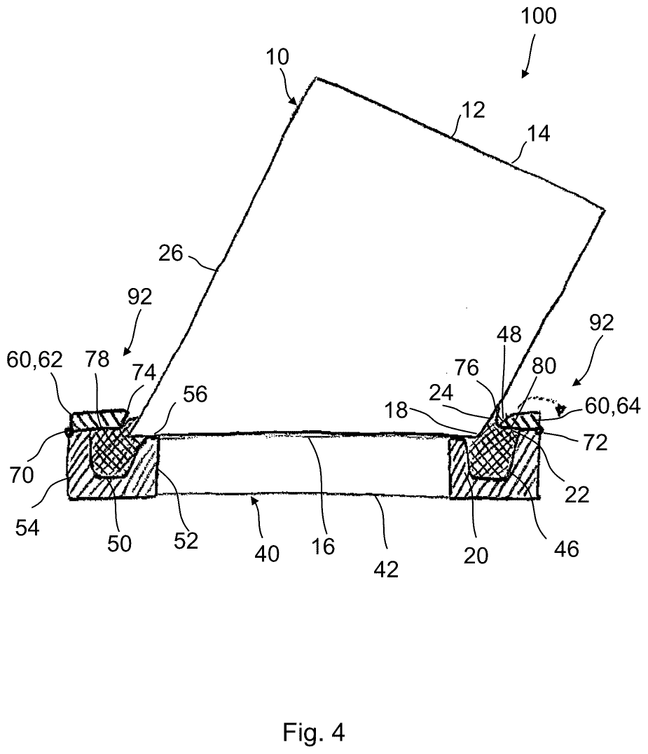

FIG. 4 shows a longitudinal section through the casting device 100 according to FIG. 1 with a placed-on filter element 10 of a different configuration and foamed-on seal 20.

In the illustration in FIG. 4, a seal 20 is already foamed on so as to extend circumferentially.

The filter element 10 comprises a filter body 12 slanted in relation to the end face 16. The casting shell 40 is configured functionally as in the embodiment illustrated in FIG. 3. The cover parts 62, 64 however are adapted to the outer side 26 of the slanted filter body 12 so that the side faces 74, 76 are formed parallel to the outer side 26. In this way, a uniform gap 48 between side faces 74, 76 and the outer side 26 can be maintained.

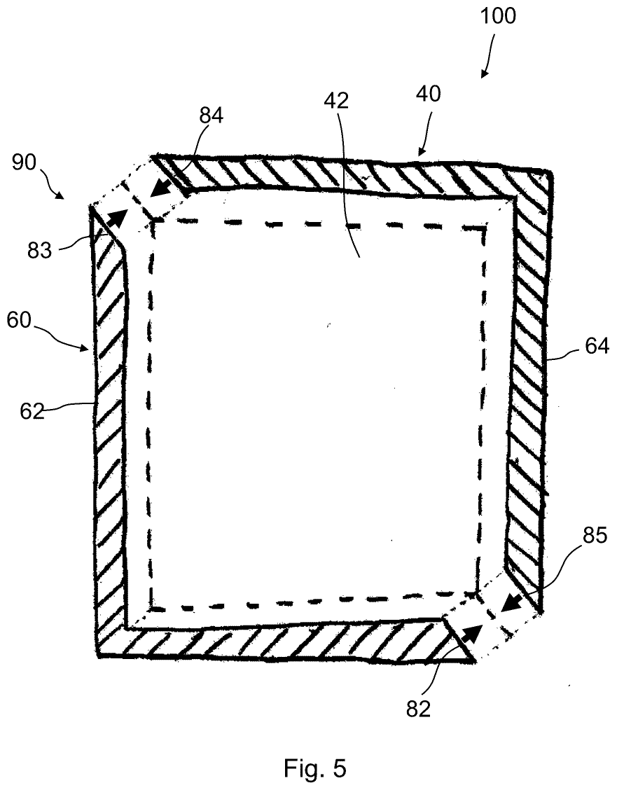

In FIG. 5, a plan view of a casting device 100 with a casting shell 40 according to another embodiment of the invention is illustrated.

The two cover parts 62, 64 are arranged at the receiving shell 42 so as to be slidable in different directions parallel to the support surface 56 for the filter body 12, respectively. The cover parts 62, 64 are illustrated in the first position 90 and can be displaced in the arrow direction into the second position 92. In this context, the end faces 82 and 85 or 83 and 84 of the two cover parts 62, 64 then adjoin each other seal-tightly.

Due to the separation of the two cover parts 62, 64 formed in the diagonal of the rectangular casting shell 40, there is only a small displacement travel required in order to move the two cover parts 62, 64 between the first position 90 and the second position 92.

A mechanism for locking or catching the two cover parts 62, 64 can be provided also as in the first embodiments in FIGS. 1 and 2. The movement of the two cover parts 62, 64 between first and second position 90, 92 can be realized, for example, by hand. Alternatively, a drive unit can also be provided however.

In an alternative embodiment, not illustrated, a combination of the two variants with pivotable and slidable cover parts is possible also.

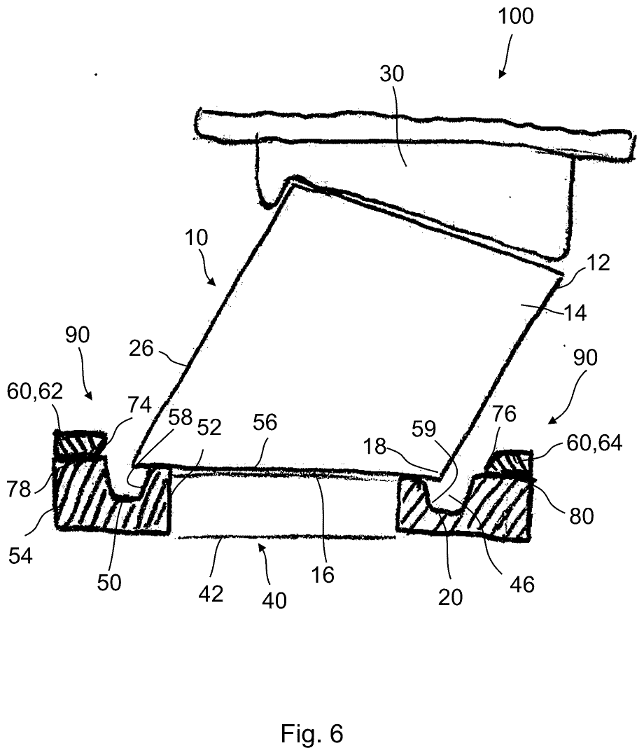

FIG. 6 shows a longitudinal section through the casting device 100 according to FIG. 5 with placed-on filter element 10.

As in the embodiment in FIG. 4, the filter element 10 comprises a filter body 12 which is slanted in relation to the end face 16. After placing the filter body 12 on the receiving shell 42, the filter body 12 is fixed by a hold-down 30 so that floating up of the filter body 12 with the casting material can be prevented in the casting process.

The casting shell 40 is illustrated with the cover parts 62, 64 in the first position 90. The grooves 50 are open. It can be seen that the side faces 74, 76 of the cover parts 62, 64 are adapted to the slanted outer side 26 of the filter body 12 in regard to shape and embodied parallel thereto.

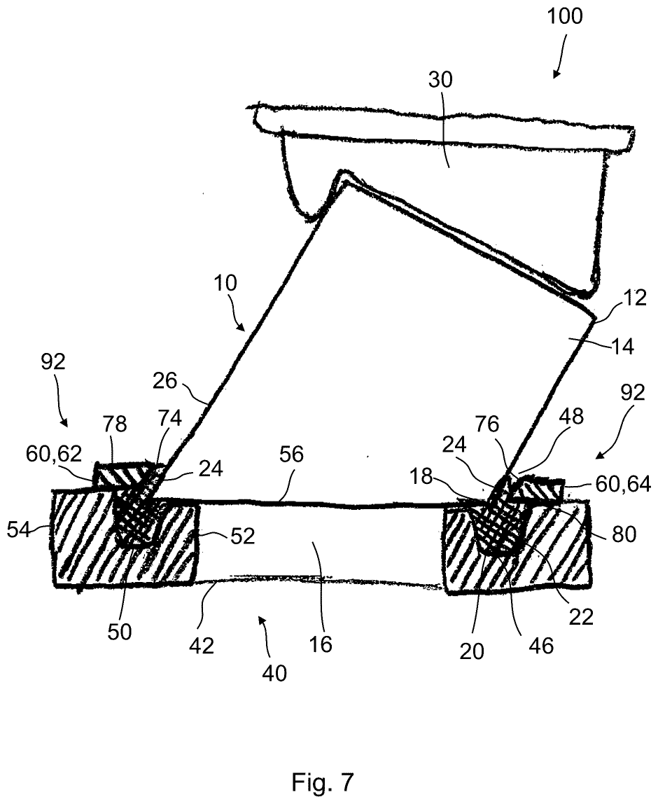

FIG. 7 shows a longitudinal section through the casting device 100 according to FIG. 5 with filter element 10 placed thereon and foamed-on seal 20.

The foaming process of the casting material has already taken place, the seal 20 is formed. At both sides of the filter body 12, in the gaps 48 between side faces 74, 76 of the cover part 62, 64 and the outer side 26 of the filter body 12 a protrusion 24 of the casting material has formed, respectively, which extends upwardly along the outer side 26.

Prior to removing the filter body 12 from the receiving shell 42, the hold-down 30 can be expediently removed again.

In accordance with the illustrated embodiments with a seal circumferentially extending around an end face of a filter body, an end disk for closing the open end faces of a filter body in the form of a hollow body can be produced also. The filter body is, for example, a folded bellows whose end folds are connected to each other so that a hollow body is formed. The latter can be embodied cylindrically, for example, circular cylindrically, or conically. The end disks can be embodied open or closed and at the same time can be designed for forming a seal in relation to a housing component.

### REFERENCE CHARACTERS

10 filter element
12 filter body
14 filter medium
16 end face
18 outer rim
20 seal
22 seal surface
24 protrusion
26 outer side
28 protective rim
30 hold-down
32 release agent spraying device
40 casting shell
42 receiving shell
46 cavity
48 gap
50 groove
52 groove wall inner side
54 groove wall outer side
56 support surface
58 inner surface
59 inner surface
60 cover
62 cover part
64 cover part
66 cover part
68 cover part
70 axis
71 axis
72 axis
73 axis
74 side face
76 side face
78 bottom side
80 bottom side
82 end face
83 end face
84 end face
85 end face
86 end face
87 end face
88 end face
89 end face
90 first position
92 second position
100 casting device

What is claimed is:

1. A casting shell for producing a filter element for filtering a fluid comprising a filter body and one or more components, selected from the group consisting of a seal and an end disk and at least partially circumferentially extending around the filter body, the casting shell comprising:
a receiving shell comprising a groove and a support surface, wherein the groove is configured to receive a casting material, and wherein the support surface is configured to support a filter body;
a cover comprising at least two cover parts arranged so as to be movable separately from to each other in relation to the receiving shell, wherein the at least two cover parts open the groove in a first position and in a second position, with a filter body inserted as intended in the casting shell, substantially cover the groove;
wherein a bottom side of the at least two cover parts faces in the second position a cavity formed by the groove and wherein the bottom side is configured to mold a seal surface or a function surface of said one or more components.

2. The casting shell according to claim 1, wherein the at least two cover parts each are supported at the receiving shell so as to be movable separately from each other.

3. The casting shell according to claim 1, wherein the groove comprises a groove wall at an inner side of the groove and a groove wall at an outer side of the groove, wherein the groove wall at the inner side of the groove is lower than the groove wall at the outer side of the groove, wherein the groove wall at the inner side of the groove comprises the support surface.

4. The casting shell according to claim 3, wherein the support surface is horizontal.

5. The casting shell according to claim 1, wherein the at least two cover parts each comprise an axis arranged parallel to the support surface, wherein the at least two cover parts each are arranged at the receiving shell so as to be pivotable about the respective axis.

6. The casting shell according to claim 5, wherein the at least two cover parts each are pivotable about the respective axis by 180°.

7. The casting shell according to claim 1, wherein the at least two cover parts are arranged at the receiving shell so as to be slidable parallel to the support surface in different directions, respectively.

8. The casting shell according to claim 1, further comprising a fastening device configured to fix the at least two cover parts in the second position, wherein the fastening device is a mechanical fastening device; a magnetic fastening device; or a mechanical fastening device and a magnetic fastening device.

9. The casting shell according to claim 1, wherein the at least two cover parts in the second position provide a free space in the casting shell, wherein the free space is larger than a cross section of the filter body inserted as intended in the casting shell.

10. The casting shell according to claim 1, wherein the at least two cover parts comprise side faces bordering an outer side of the filter body in the second position, wherein the side faces are embodied to have a complementary shape to the outer side of the filter body.

11. The casting shell according to claim 1, wherein the at least two cover parts comprise end faces bordering one another and seal-tightly adjoining each other in the second position.

12. A casting device comprising:
a casting shell according to claim 1; and
a metering device configured to fill the casting material into the groove of the receiving shell.

13. The casting device according to claim 12, wherein the at least two cover parts are embodied so as to seal-tightly adjoin the filter body inserted as intended into the casting shell.

14. The casting device according to claim 12, wherein the at least two cover parts are formed so as to be spaced apart by a gap from the filter body inserted as intended into the casting shell.

15. The casting device according to claim 12, further comprising a hold-down configured to fix the filter body during a casting process in the casting shell.

16. A method for producing a filter element for filtering a fluid comprising a filter body and one or more components, selected from the group consisting of a seal and an end disk and at least partially circumferentially extending around the filter body, the method comprising:
providing a casting shell according to claim 1;
placing a filter body, in the first position of the at least two cover parts, with an end face thereof as intended on the receiving shell so that the filter body with an outer rim thereof at least partially projects into the groove of the receiving shell;
filling the casting material into the groove of the receiving shell;
moving separately from each other the at least two cover parts into the second position;
the receiving shell and the at least two cover parts in the second position enclosing the cavity formed by the groove; and
the bottom side of the at least two cover parts facing the cavity in the second position molding the seal surface or the function surface.

17. The method according to claim 16, further comprising:
forming the seal at the outer rim of the end face of the filter body;
moving back the at least two cover parts into the first position;
removing the filter body from the support surface of the receiving shell.

18. The method according to claim 16, further comprising providing inner surfaces of the groove and the bottom side of the at least two cover parts with a release agent prior to placing the filter body on the receiving shell.

19. The method according to claim 16, further comprising fixing the filter body by a hold-down in the receiving shell after placing the filter body on the receiving shell and, prior to removing the filter body from the support surface of the receiving shell, removing the hold-down.
